(19) United States
(12) Patent Application Publication
(10) Pub. No.: US 2009/0000494 A1
(43) Pub. Date: Jan. 1, 2009

(54) Household soybean milk and tofu maker

(76) Inventor: Hong-bae Kim, Koyang-city (KR)

Correspondence Address: SHLESINGER, ARKWRIGHT & GARVEY LLP, Suite 600, 1420 King Street, Alexandria, VA, 22314, US

(21) Appl. No.: 11/984,833

(22) Filed: Nov. 21, 2007

Related U.S. Application Data
(63) Continuation-in-part of application No. 11/812,805, filed on Jun. 21, 2007.
Application No. 11/812,805 is a continuation-in-part of application No. 10/960,753, filed on Oct. 8, 2004, now abandoned.
Application No. 10/960,753 is a continuation-in-part of application No. 11/812,805, filed on Jun. 21, 2007.
Application No. 11/812,805 is a continuation-in-part of application No. 10/960,750, filed on Oct. 8, 2004, now abandoned.
Application No. 10/960,750 is a continuation-in-part of application No. 11/812,805, filed on Jun. 21, 2007.
Application No. 11/812,805 is a continuation-in-part of application No. 10/960,760, filed on Oct. 8, 2004, now abandoned.
Application No. 10/960,760 is a continuation-in-part of application No. 11/812,805, filed on Jun. 21, 2007.
Application No. 11/812,805 is a continuation-in-part of application No. 10/960,759, filed on Oct. 8, 2004, now abandoned.
Application No. 10/960,759 is a continuation-in-part of application No. 11/812,805, filed on Jun. 21, 2007.
Application No. 11/812,805 is a continuation-in-part of application No. 10/960,751, filed on Oct. 8, 2004, now abandoned.
Application No. 10/960,751 is a continuation-in-part of application No. 11/812,805, filed on Jun. 21, 2007.
Application No. 11/812,805 is a continuation-in-part of application No. 10/960,745, filed on Oct. 8, 2004, now abandoned.

(30) Foreign Application Priority Data
Oct. 8, 2003 (KR) 2003-31673
Oct. 8, 2003 (KR) 2003-31674
Oct. 8, 2003 (KR) 2003-31676
Oct. 8, 2003 (KR) 2003-31677
Oct. 8, 2003 (KR) 2003-32482
Oct. 8, 2007 (KR) 2003-31675

(51) Int. Cl. A23J 1/14; A23J 3/16

(52) U.S. Cl. 99/483; 99/510; 99/513

(57) ABSTRACT

Household soybean milk and tofu maker couples a housing and a main body, locks both, blocks a power supply when both are uncoupled, thereby preventing an accident, prevents impurities from getting into main body through an air vent, externally exhausts steam generated from main body through steam exhaust pipe while manufacturing soybean milk or tofu. Soybean milk and tofu maker includes filter net containing food materials including grain such as soybeans; container section including grinding blade for grinding food materials in filter net, and heater heating food materials ground by blade; cover connected to upper surface of container section and sealing container section; a main body including an insertion section receiving container section on upper portion thereof, drive motor contacting exterior surface of container section and applying rotational force to grinding blade, a controller controlling heater and drive motor, and a control panel controlling controller.

### CROSS-REFERENCE TO RELATED APPLICATIONS

This application is a continuation-in-part of U.S. patent application Ser. No. 11/812,805, filed Jun. 21, 2007, and U.S. patent application Ser. No. 11/812,805, filed Jun. 21, 2007 is a continuation-in-part of U.S. patent application Ser. No. 10/960,753, filed Oct. 8, 2004, which claims priority of Korean Application No. 2003-31673, filed 8 Oct. 2003, and each of which is incorporated herein by reference;

This application is a continuation-in-part of U.S. patent application Ser. No. 11/812,805, filed Jun. 21, 2007, and U.S. patent application Ser. No. 11/812,805, filed Jun. 21, 2007 is a continuation-in-part of U.S. patent application Ser. No. 10/960,750, filed Oct. 8, 2004, which claims priority of Korean Application No. 2003-31674, filed 8 Oct. 2003, and each of which is incorporated herein by reference;

This application is a continuation-in-part of U.S. patent application Ser. No. 11/812,805, filed Jun. 21, 2007, and U.S. patent application Ser. No. 11/812,805, filed Jun. 21, 2007 is a continuation-in-part of U.S. patent application Ser. No. 10/960,760, filed Oct. 8, 2004, which claims priority of Korean Application No. 2003-31675, filed 8 Oct. 2003, and each of which is incorporated herein by reference;

This application is a continuation-in-part of U.S. patent application Ser. No. 11/812,805, filed Jun. 21, 2007, and U.S. patent application Ser. No. 11/812,805, filed Jun. 21, 2007 is a continuation-in-part of U.S. patent application Ser. No. 10/960,759, filed Oct. 8, 2004, which claims priority of Korean Application No. 2003-31676, filed 8 Oct. 2003, and each of which is incorporated herein by reference;

This application is a continuation-in-part of U.S. patent application Ser. No. 11/812,805, filed Jun. 21, 2007, and U.S. patent application Ser. No. 11/812,805, filed Jun. 21, 2007 is a continuation-in-part of U.S. patent application Ser. No. 10/960,751, filed Oct. 8, 2004, which claims priority of Korean Application No. 2003-31677, filed 8 Oct. 2003, and each of which is incorporated herein by reference; and

This application is a continuation-in-part of U.S. patent application Ser. No. 11/812,805, filed Jun. 21, 2007, and U.S. patent application Ser. No. 11/812,805, filed Jun. 21, 2007 is a continuation-in-part of U.S. patent application Ser. No. 10/960,745, filed Oct. 8, 2004, which claims priority of Korean Application No. 2003-32482, filed 8 Oct. 2003, and each of which is incorporated herein by reference.

### BACKGROUND OF THE INVENTION

1. Field of the Invention

The present invention relates to a household soybean milk and tofu maker, and more particularly, to a household soybean milk and tofu maker, which exactly couples a main body and a housing, tightly locks both of them, if they are not coupled, blocks power supply in order to prevent a safety accident from being occurred, prevents impurities from easily getting into the main body through an air vent, and externally exhausts steam generated from the main body during a manufacturing process through a steam exhaust pipe.

2. Description of the Related Art

Conventional methods of making soybean milk and tofu are inefficient since processes are separately performed, a manufacturing process is complicated, and it takes a lot of time.

In order to address these problems, apparatuses for easily making soybean milk and tofu at home have been disclosed in the name of the same applicant: Korean Patent Registration No. 99-225772 (published on Oct. 15, 1999) entitled with “Apparatus for Producing Household Tofu”, Korean Patent Registration No. 2000-228659 (published on Mar. 15, 2000) entitled with “Apparatus for Producing Household Tofu”, Korean U.M. Registration No. 158856 (registered on Jul. 16, 1999) entitled with “Apparatus for Producing Household Tofu”, and Korean U.M. Registration No. 250843 (published on Oct. 5, 2001) entitled with “Apparatus for Producing Household Tofu With Blade Fixed Type Unit”.

Conventional household soybean milk and tofu makers will now be described with reference to FIG. 1.

FIG. 1 is a cross-sectional view of a conventional household soybean milk and tofu maker. Referring to FIG. 1, the conventional household soybean milk and tofu maker comprises a housing 1 which has a cavity to contain water therein, a main body 2 that is provided on an upper portion of the housing 1 to open or close the housing 1 like a lid, a drive motor 3 that is installed in a predetermined portion of the main body 2 and generates rotating power when electricity is applied thereto, a drive shaft 4 that transmits the rotating power of the drive motor 3, a grinding blade 5 that is provided at an end of the drive shaft 4, a heater 6 that downwardly extends from the main body 2, and generates heat when electricity is applied thereto, thereby heating an interior of the housing 1, a temperature sensing bar 7 that detects the temperature of the interior of the housing 1, and a filter net 8 that is detachably mounted to a predetermined portion of the main body 2 and contains beans therein.

The operation of the conventional household soybean milk and tofu maker having the construction described above will now be described.

First, a user puts water into the housing 1. The user puts beans into the filter net 7 which is detached from the main body 2, and couples the filter net 8 having beans to the lower portion of the main body 2. Thereafter, the user adheres the main body 2 to the upper portion of the housing 1 so that the filter net 8 is put into the housing 1.

Next, when the user turns on a power switch (not shown) to apply electricity to the household soybean milk and tofu maker, a control section (not shown) operates a heating bar 6 and the temperature sensing bar 7 so that soybeans are first heated to a predetermined temperature during a predetermined time of period.

After soybeans are completely heated, the control section (not shown) operates the drive motor 3 to grind soybeans contained in the filter net 8 by using the grinding blade 5 connected to the distal end of the drive shaft 4. While the grinding blade 5 grinds the soybeans, vortex flow is induced in the water received in the housing 1 by the rotating motion of the grinding blade 5. Due to this vortex flow, fine soybean particles which reside in the filter net 8 are moved out of the filter net 8. Therefore, the soybeans grounded by the grinding blade 5 are divided into soybean juice which resides out of the filter net 8 and residue which resides in the filter net 8.

Thereafter, the control section (not shown) actuates again the heating bar 6 and the temperature sensing bar 7 to heat the soybean juice to a second predetermined temperature, by which soybean milk is prepared.

When it is necessary to produce tofu, the user takes out the hot soybean milk from the housing 1. Then, the hot soybean milk is added with a coagulant and then stirred, so that the soybean milk is coagulated. Thereupon, by transferring the resultant silken tofu into a draining container and pressing the silken tofu to drain a part of the water content, tofu, that is, pressed tofu is finally made.

An air vent 9 installed in the upper portion of the main body 2 circulates heat generated from electronic devices including the drive motor 3 installed in the main body 2 out of the main body 2 to radiate heat, thereby protecting a device from being overheated.

However, when the main body 2 is not exactly coupled to the upper part of the housing 1, the conventional household soybean milk and tofu maker causes vibration and noise. When the main body 2 is separated from the housing 1 due to vibration or an external shock, safety accidents caused by the externally exposed grinding blade 5 occur.

When the main body 2 and the housing 1 are not tightly coupled, if the conventional household soybean milk and tofu maker falls down due to a user's mistake or an external shock, hot liquid flows out of the maker, causing safety accidents.

The structure of the air vent 9 installed on the upper part of the main body 2 in order to radiate heat generated from the main body 2 is inefficient, which does not completely prevent impurities from getting into the main body 2 through the air vent 9 when the conventional household soybean milk and tofu maker is cleaned.

The conventional household soybean milk and tofu maker does not properly exhaust a great amount of steam that is generated from the housing 1 when boiling soybeans, which increases the pressure of the housing 1.

### SUMMARY OF THE INVENTION

The present invention provides a household soybean milk and tofu maker, which accurately couples a housing and a main body and maintains the combination by the weight of the main body, thereby preventing vibration, noise, and safety accident.

The present invention also provides a household soybean milk and tofu maker, which tightly locks a main body and a housing, thereby reinforcing resistance to shock, and does not drain hot liquid even though the make falls down due to a user's mistake or an external shock, thereby preventing a safety accident from occurring.

The present invention also provides a household soybean milk and tofu maker, which blocks power supply at a primary end using a large volume switch disposed in a primary end of a transformer when a main body and a housing are not coupled, thereby preventing a safety accident from occurring, and applies power supply using a vibration proof switch when the main body and the housing are coupled, thereby preventing a power supply failure while being operated.

The present invention also provides a household soybean milk and tofu maker, which prevents impurities from getting into a main body through an air vent, and easily identifies the location of the air vent.

The present invention also provides a household soybean milk and tofu maker, which comprises a steam exhaust pipe through a main body for connecting a cavity of the main body and outside, thereby externally exhausting steam generated from the main body through the steam exhaust pipe while manufacturing soybean milk or tofu.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view of a conventional household soybean milk and tofu maker;

FIG. 2 is a perspective view of a household soybean milk and tofu maker according to an embodiment of the present invention;

FIG. 3 is a perspective view of a household soybean milk and tofu maker according to another embodiment of the present invention;

FIG. 4 is a perspective view of a household soybean milk and tofu maker when being locked according to another embodiment of the present invention;

FIG. 5 is a cross-sectional view of the household soybean milk and tofu maker of FIG. 4 taken along a line A-A in FIG. 4, according to an embodiment of the present invention;

FIG. 6 is a perspective view of the household soybean milk and tofu maker of FIG. 4 when being unlocked according to another embodiment of the present invention;

FIG. 7 is an exploded perspective view of a household soybean milk and tofu maker according to another embodiment of the present invention;

FIG. 8 is a perspective view of a household soybean milk and tofu maker of FIG. 7 when being locked according to another embodiment of the present invention;

FIG. 9 is a main front sectional view of a household soybean milk and tofu maker of FIG. 7 when being unlocked according to another embodiment of the present invention;

FIG. 10 is a main side sectional view of a household soybean milk and tofu maker of FIG. 7 when being unlocked according to another embodiment of the present invention;

FIG. 11 is a main perspective view of a household soybean milk and tofu maker when being unlocked according to another embodiment of the present invention;

FIG. 12 is a main perspective view of the household soybean milk and tofu maker of FIG. 11 when being locked according to another embodiment of the present invention;

FIG. 13 is a cross-sectional view of the household soybean milk and tofu maker of FIG. 12 taken along a line B-B in FIG. 12, according to an embodiment of the present invention;

FIG. 14 is a perspective view of a household soybean milk and tofu maker according to another embodiment of the present invention;

FIGS. 15A and 15B are main cross-sectional views of the household soybean milk and tofu maker of FIG. 14 according to another embodiment of the present invention;

FIG. 16 is a circuit diagram of the household soybean milk and tofu maker of FIG. 14 according to another embodiment of the present invention;

FIG. 17 is a perspective view of a household soybean milk and tofu maker according to another embodiment of the present invention;

FIG. 18 is a main perspective view of the household soybean milk and tofu maker of FIG. 17 according to another embodiment of the present invention;

FIG. 19 is a cross-sectional view of the household soybean milk and tofu maker of FIG. 18 taken along a line C-C in FIG. 18, according to an embodiment of the present invention;

FIG. 20 is a main cross-sectional view of a household soybean milk and tofu maker according to another embodiment of the present invention;

FIG. 21 is a cross-sectional view of a household soybean milk and tofu maker according to another embodiment of the present invention;

FIG. 22 is a main cross-sectional view of a household soybean milk and tofu maker according to another embodiment of the present invention;

FIG. 23 is a perspective view of a household soybean milk and tofu maker according to another embodiment of the present invention;

FIG. 24 is an exploded perspective view of the household soybean milk and tofu maker of FIG. 23 according to another embodiment of the present invention;

FIG. 25 is an exploded perspective view of the household soybean milk and tofu maker of FIG. 23 to which a grinding blade is coupled according to another embodiment of the present invention;

FIG. 26 is a cross-sectional view of the household soybean milk and tofu maker of FIG. 23 according to another embodiment of the present invention;

FIG. 27 is an exploded perspective view of a household soybean milk and tofu maker according to another embodiment of the present invention;

FIG. 28 is an exploded perspective view of a household soybean milk and tofu maker according to another embodiment of the present invention;

FIG. 29 is a perspective view of a household soybean milk and tofu maker according to another embodiment of the present invention;

FIG. 30 is a perspective view of a household soybean milk and tofu maker according to another embodiment of the present invention;

FIG. 31 is an exploded perspective view of the household soybean milk and tofu maker of FIG. 30 according to another embodiment of the present invention;

FIG. 32 is an exploded perspective view of the household soybean milk and tofu maker of FIG. 30 to which a grinding blade is coupled according to another embodiment of the present invention;

FIG. 33 is a cross-sectional view of the household soybean milk and tofu maker of FIG. 30 according to another embodiment of the present invention; and

FIG. 34 is an exploded perspective view of a household soybean milk and tofu maker according to another embodiment of the present invention.

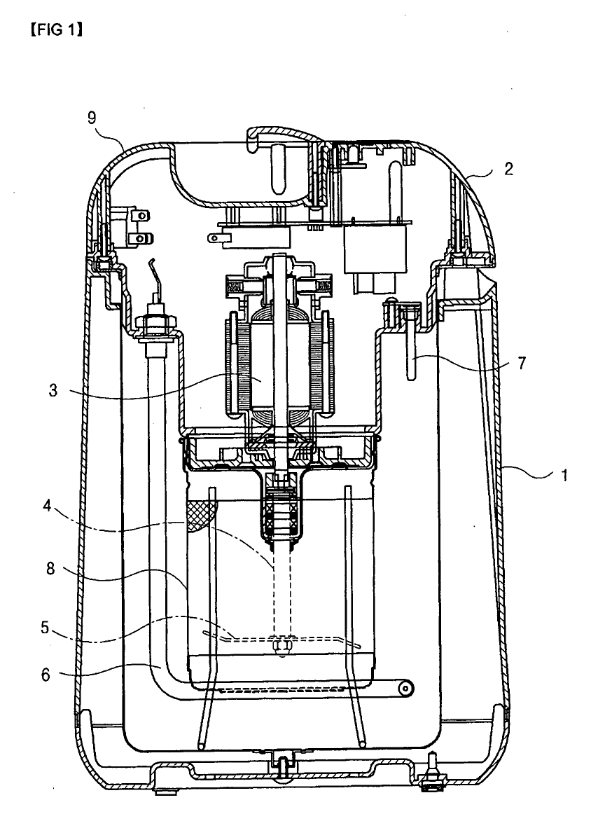

### DETAILED DESCRIPTION OF THE INVENTION

Hereinafter, the present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. The attached drawings for illustrating preferred embodiments of the present invention are referred to in order to gain a sufficient understanding of the present invention, the merits thereof, and the objectives accomplished by the implementation of the present invention.

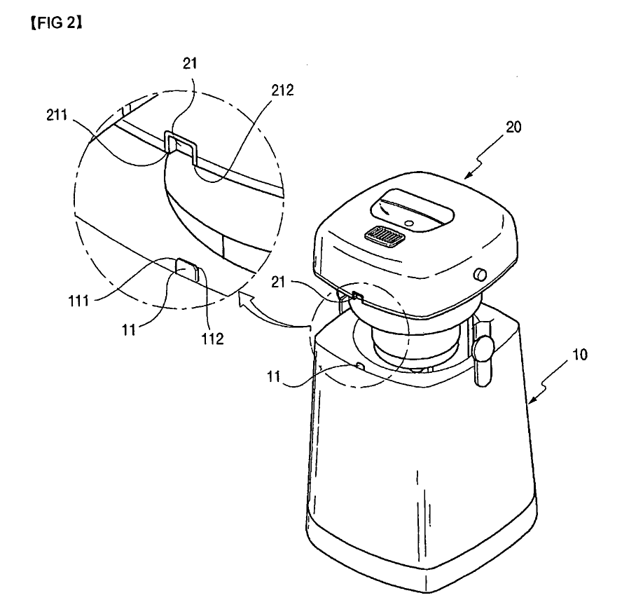

FIG. 2 is a perspective view of a household soybean milk and tofu maker according to an embodiment of the present invention. Referring to FIG. 2, the household soybean milk and tofu maker comprises a housing 10 having a cavity, and a main body 20 formed on an upper portion of the housing 10 to open or close the housing 10 like a lid, and including a filter, a drive motor, a grinding blade, and a heater, in which a protrusion 11 is formed on an end of the upper portion of the housing 10 and a fixing groove 21 is formed on an end of the lower portion of the main body 20 and is fixed to the protrusion 11.

In order to smoothly fix the protrusion 11 to the fixing groove 21, the protrusion 21 is rounded so that both corners 111 and 112 thereof have a smooth curvature.

In order to easily fix the fixing groove 21 to the protrusion 11, the fixing groove 21 is rounded so that both corners 211 and 212 thereof have a smooth curvature.

The protrusion 11 and the fixing groove 21 may be formed in opposite directions. In more detail, the fixing groove 21 is formed on the upper portion of the housing 10, and the protrusion 11 is formed on the lower portion of the main body 20.

The operation of the household soybean milk and tofu maker having the above-mentioned construction will now be described.

In order to make soybean milk or tofu, when a user puts water and soybeans into the housing 10 and couples the housing 10 and the main body 20, if the location of the protrusion 11 formed on the housing 10 and the location of the fixing groove 21 of the main body 20 match each other and the main body 20 is placed on the upper portion of the housing 10, the protrusion 11 formed on an end of the upper portion of the housing 10 is tightly fixed to the fixing groove 21 formed on an end of the lower portion of the main body 20.

If the location of the protrusion 11 formed on the housing 10 and the location of the fixing groove 21 of the main body 20 do not match each other, the protrusion 11 is fixed to the fixing groove 21 owing to weight of the main body 20 including relatively heavy parts such as the filter, the drive motor, the drive shaft, the grinding blade, and the like, so that the protrusion 11 and the fixing groove 21 can be easily fixed to each other continuously. The both corners 111 and 112 and 211 and 212 of the protrusion 11 and the fixing groove 21 are rounded to have a smooth curvature in order to easily fix the protrusion 11 to the grinding groove 21.

The combination of the housing 10 and the main body 20 does not generate vibration caused by a mismatch therebetween.

A pair of the protrusion 11 and the fixing groove 21 is not only formed but also a plurality of pairs thereof results in a more tight combination between housing 10 and the main body 20.

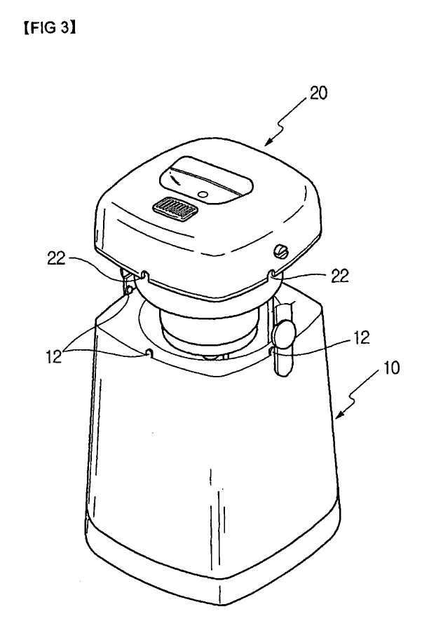

FIG. 3 is a perspective view of a household soybean milk and tofu maker according to another embodiment of the present invention. Referring to FIG. 3, the household soybean milk and tofu maker comprises a housing 10 having a cavity, and a main body 20 formed on an upper portion of the housing 10 to open or close the housing 10 like a lid, and including a filter, a drive motor, a grinding blade, and a heater, in which a plurality of protrusions 11 are formed on an end of the upper portion of the housing 10 and a plurality of fixing grooves 21 are formed on an end of the lower portion of the main body 20 and are fixed to the plurality of protrusions 11.

In order to smoothly fix the plurality of protrusions 11 to the plurality of fixing grooves 21, they may be rounded so that both corners thereof have a smooth curvature.

The plurality of protrusions 11 to the plurality of fixing grooves 21 may be formed in opposite directions. In more detail, the plurality of fixing grooves 21 are formed on the upper portion of the housing 10, and the plurality of protrusions 11 are formed on the lower portion of the main body 20.

The operation of the household soybean milk and tofu maker having the above-mentioned construction will now be described.

In order to make soybean milk or tofu, when a user puts water and soybeans into the housing 10 and couples the housing 10 and the main body 20, if the locations of the plurality of protrusions 11 formed on the housing 10 and the locations of the plurality of fixing grooves 21 of the main body 20 match each other and the main body 20 is placed on the upper portion of the housing 10, the plurality of protrusions 11 formed on an end of the upper portion of the housing 10 is tightly fixed to the plurality of fixing grooves 21 formed on an end of the lower portion of the main body 20.

If the locations of the plurality of protrusions 11 formed on the housing 10 and the locations of the plurality of fixing grooves 21 of the main body 20 do not match each other, the plurality of protrusions 11 are fixed to the plurality of fixing grooves 21 owing to weight of the main body 20 including relatively heavy parts such as the filter, the drive motor, the drive shaft, the grinding blade, and the like, so that the plurality of protrusions 11 and the fixing groove 21 can be easily fixed to each other continuously.

The both corners of the plurality of protrusions 11 and the plurality of fixing grooves 21 are rounded to have a smooth curvature in order to easily fix the plurality of protrusions 11 to the plurality of fixing grooves 21.

The combination of the housing 10 and the main body 20 does not generate vibration caused by a mismatch therebetween.

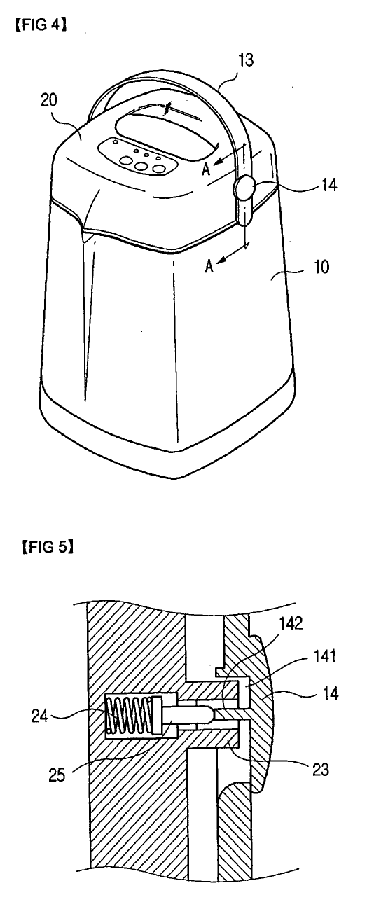

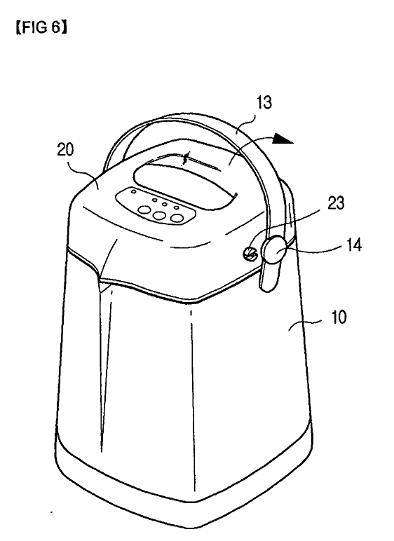

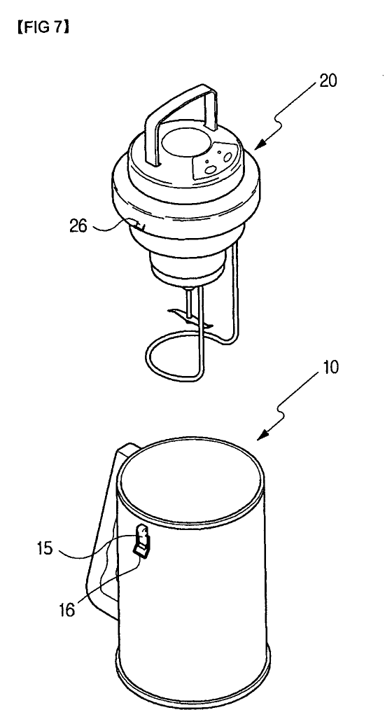

FIG. 4 is a perspective view of a household soybean milk and tofu maker when being locked according to another embodiment of the present invention. FIG. 5 is a cross-sectional view of the household soybean milk and tofu maker of FIG. 4 taken along a line A-A in FIG. 4, according to an embodiment of the present invention. FIG. 6 is a perspective view of a household soybean milk and tofu maker of FIG. 4 when being unlocked according to another embodiment of the present invention.

Referring to FIGS. 4 through 6, the household soybean milk and tofu maker comprises a housing 10 having a cavity, and a main body 20 formed on an upper portion of the housing 10 to open or close the housing 10 like a lid, and including a filter, a drive motor, a grinding blade, and a heater, in which a rotating handle 13 is formed on the upper portions of both sides of the housing 10 in order to move the housing 10, the locking section 14 having an engaging hole 141 and an engaging piece 142 is formed at an end of the inner portion of the handle 13, a protrusion piece 23 is protruded from an end of an exterior portion of the main body 20 in order to be coupled with the engaging piece 141 of the locking section 14, and a compression piece 25 is elastically supported by a spring 24 at an end of the main body 20 in order to push the engaging piece 142.

The handle 13 is in the shape of a hair band, has a predetermined width, and rotates with regard to the housing 10.

The compression piece 25 and a spring 24 are buried in the middle of the protrusion piece 23.

The compression piece 25 can be a sensor for sensing the coupling of the housing 10 and the main body 20, or a switch for forming a current path to apply power supply when the housing 10 and the main body 20 are coupled together.

The operation of the household soybean milk and tofu maker having the above-described construction will now be described.

In order to make soybean milk or tofu, when a user puts water and soybeans into the housing 10 and couples the housing 10 and the main body 20, as shown in FIG. 4, if the user pushes up the handle 13 to the upper portion of the main body 20, as shown in FIG. 5, the protrusion piece 23 of the main body 20 is engaged to the engaging hole 141 of the locking section 14 that is formed in an end of the handle 13 and thus the protrusion piece 23 is slightly pushed down, so that the main body 20 disposed on the housing 10 is tightly coupled to the housing 10.

The engaging piece 142 of the locking portion 14 is firmly coupled by pushing the compression piece 25 that is formed on the main body 20 and that is elastically supported by the spring 24 toward the spring 24.

In this case, the compression piece 25 which is the sensor is pushed down by the engaging piece 142 when the housing 10 and the main body 20 are coupled together is switched on, senses the coupling between the housing 10 and the main body 20, and transmits a sense signal to a controller (not shown). The compression piece 25 that is the switch is pushed down by the engaging piece 142 when the housing 10 and the main body 20 are coupled together, is switched on, and forms the current path for applying power supply.

If the main body 20 and the housing 10 are coupled together, both are pressed each other by force applied by the locking section 14 that pushes down the protrusion piece 23.

Therefore, vibration does not occur due to mismatch between the main body 20 and the housing 10. Even though the household soybean milk and tofu maker falls down due to a user's mistake or external shock when being used, the contents having a high temperature are not spilt, thereby preventing a safety accident from occurring in advance.

After soybean milk and tofu are completely made, in order to separate the housing 10 and the main body 20 from each other, as shown in FIG. 6, if the handle 13 is pulled down in the arrow direction, the engaging hole 141 of the locking section 14 is released from the protrusion piece 23, so that the user can separate the main body 20 from the housing 10.

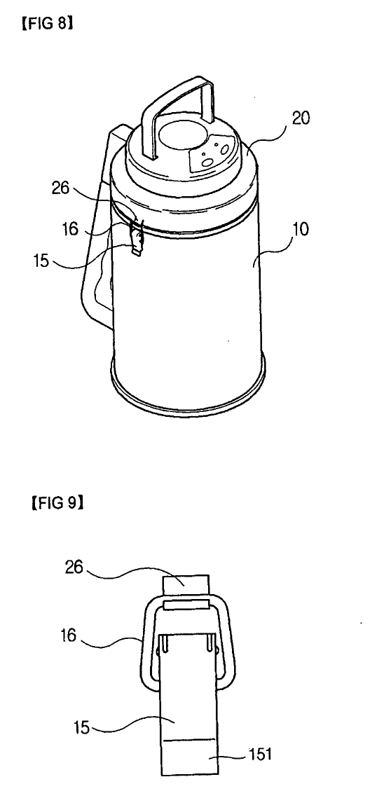

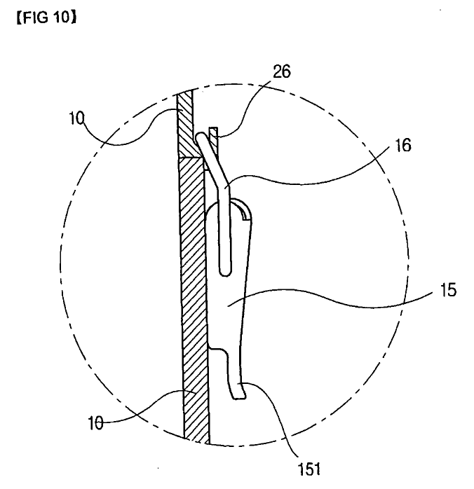

FIG. 7 is an exploded perspective view of a household soybean milk and tofu maker according to another embodiment of the present invention. FIG. 8 is a perspective view of the household soybean milk and tofu maker of FIG. 7 when being locked according to another embodiment of the present invention. FIG. 9 is a main front sectional view of the household soybean milk and tofu maker of FIG. 7 when being locked according to another embodiment of the present invention. FIG. 10 is a main side sectional view of the household soybean milk and tofu maker of FIG. 7 when being locked according to another embodiment of the present invention.

Referring to FIGS. 7 through 10, the household soybean milk and tofu maker comprises a housing 10 having a cavity, and a main body 20 formed on an upper portion of the housing 10 to open or close the housing 10 like a lid, and including a filter, a drive motor, a grinding blade, and a heater, in which a hook plate 13 that freely rotates is formed at an end of an exterior surface of the housing 10, a hook 16 that freely rotates is connected to the hook plate 15, and a locking piece 26 is protruded from an end of the main body 20 in order to hang the hook 16 thereto.

The hook 16 is in the shape of a wire surrounding the exterior surface of the hook plate 15, and has a central axis of rotation at a different location from that of the hook plate 15. The operation of the household soybean milk and tofu maker having the above-described construction will now be described.

In order to make soybean milk or tofu, when a user puts water and soybeans into the housing 10 and couples the housing 10 and the main body 20, the user rotates the hook 16 and hangs the upper portion of the hook 16 to the locking piece 26.

If the lower portion 151 of the hook plate 15 is pushed down, the upper portion of the hook 16 is pulled by the locking piece 26, and the lower portion of the hook 16 is pulled by the hook plate 15, so that the hook plate 15 and the locking piece 26 pull the hook 16 up and down in order to firmly couple the hook 16 to the locking piece 26, as shown in FIGS. 9 and 10.

The household soybean milk and tofu maker is locked after the hook 16 is coupled to the locking piece 26, so that the main body 20 is pulled down by elasticity of the hook 16, thereby tightly coupling the housing 10 and the main body 20.

Therefore, vibration does not occur due to mismatch between the main body 20 and the housing 10. Even though the household soybean milk and tofu maker falls down due to a user's mistake or external shock when being used, the contents having a high temperature are not spilt, thereby preventing a safety accident from occurring in advance.

After soybean milk and tofu are completely made, in order to separate the housing 10 and the main body 20 from each other, if the lower portion 151 of the hook plate 16 is pulled toward outside, the hook plate 16 does not pull the hook 15, and thus the upper portion of the hook 15 that is hung to the hook piece 26 is released from the hook 15, so that the user can separate the main body 20 from the housing 10.

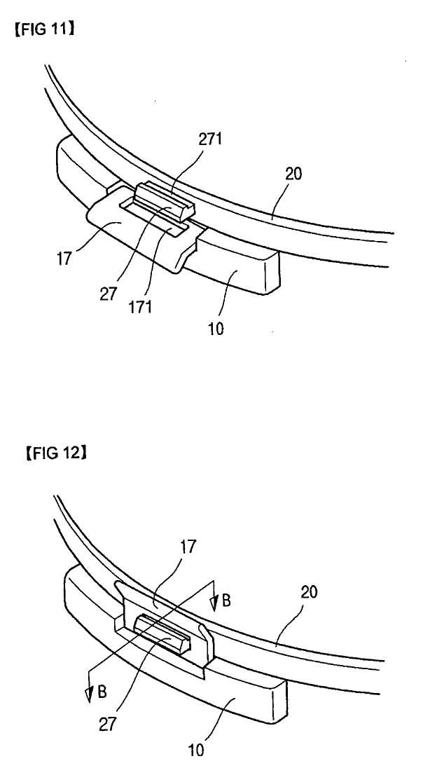

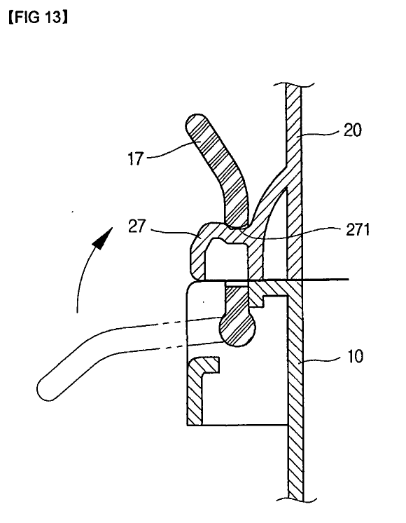

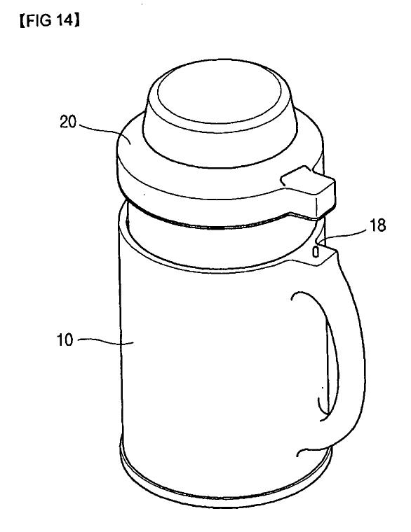

FIG. 11 is a main perspective view of a household soybean milk and tofu maker when being unlocked according to another embodiment of the present invention. FIG. 12 is a main perspective view of the household soybean milk and tofu maker of FIG. 11 when being locked according to another embodiment of the present invention. FIG. 13 is a cross-sectional view of the household soybean milk and tofu maker of FIG. 12 taken along a line B-B in FIG. 12, according to an embodiment of the present invention.

Referring to FIGS. 11 through 13, the household soybean milk and tofu maker comprises a housing 10 having a cavity, and a main body 20 formed on an upper portion of the housing 10 to open or close the housing 10 like a lid, and including a filter, a drive motor, a grinding blade, and a heater, in which a hook 17 that freely rotates is formed at an end of an exterior surface of the housing 10, and has a hollow in the middle thereof, and a locking piece 27 is coupled to the hollow of the hook 17 and is protruded from an end of the main body 20 in order to hang the hook 17 thereto.

The hook 17 includes an engaging hole 171 by which the hook 17 is coupled to the locking piece 27.

The locking piece 27 includes a locking groove 271 by which the hook 17 is not easily released from the locking piece 27 but a locking state can be maintained when the hook 17 is coupled to the locking piece 27.

The operation of the household soybean milk and tofu maker having the above-described construction will now be described.

In order to make soybean milk or tofu, when a user puts water and soybeans into the housing 10 and couples the housing 10 and the main body 20, the user rotates the hook 17 upward in the arrow direction and hangs the hook 17 to the locking piece 27 as shown in FIG. 13.

If the hook 17 is hung to the locking piece 27, the locking piece 27 passes through the engaging hole 271 formed in the middle of the hook 17 and thus the hook 17 is received in the locking groove 271, so that the hook 17 is firmly coupled to the locking piece 27.

In this case, the main body 20 is pulled down by elasticity of the hook 17, thereby tightly coupling the housing 10 and the main body 20.

Therefore, vibration does not occur due to mismatch between the main body 20 and the housing 10. Even though the household soybean milk and tofu maker falls down due to a user's mistake or external shock when being used, the contents having a high temperature are not spilt, thereby preventing a safety accident from occurring in advance.

After soybean milk and tofu are completely made, in order to separate the housing 10 and the main body 20 from each other, if a force is applied to the hook 17 and the hook 17 is rotated in a direction opposite to the arrow shown in FIG. 13, the hook 17 is released from the locking groove 271 of the locking piece 27 and thus the hook 17 is escaped from the locking piece 27, so that the user can separate the main body 20 from the housing 10.

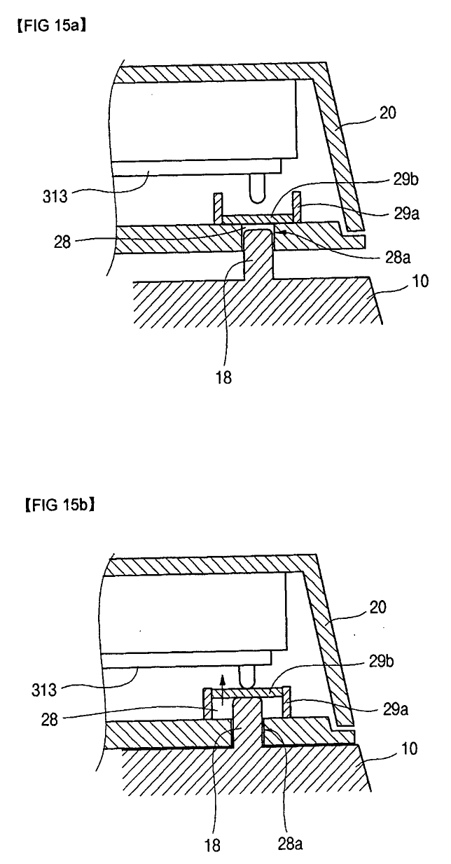

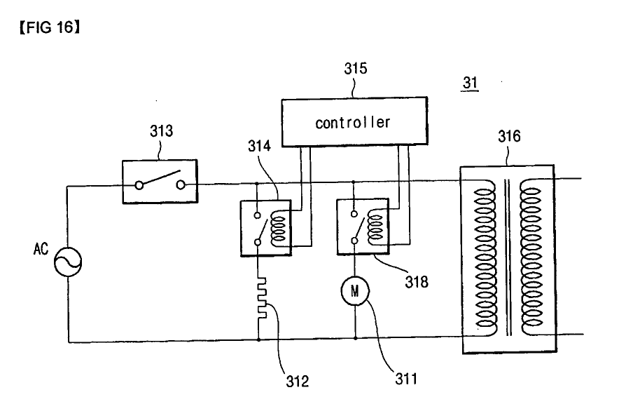

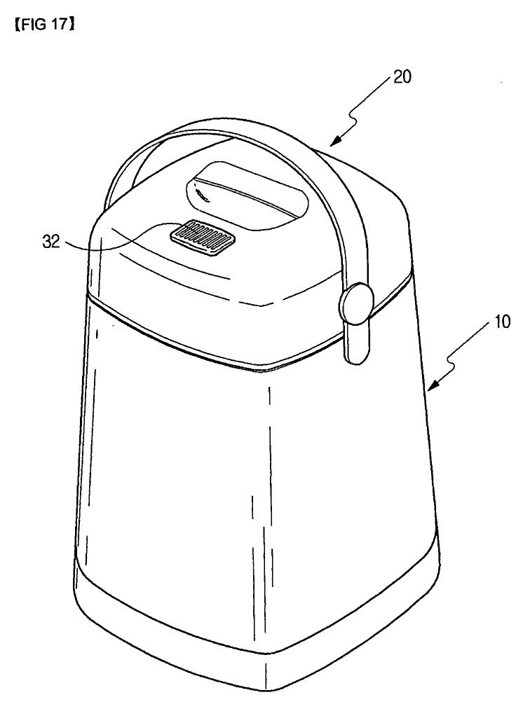

FIG. 14 is a perspective view of a household soybean milk and tofu maker according to another embodiment of the present invention. FIGS. 15A and 15B are main cross-sectional views of the household soybean milk and tofu maker of FIG. 14 according to another embodiment of the present invention. FIG. 16 is a circuit diagram of the household soybean milk and tofu maker of FIG. 14 according to another embodiment of the present invention.

Referring to FIGS. 14 through 16, the household soybean milk and tofu maker comprises a housing 10 having a cavity, and a main body 20 formed on an upper portion of the housing 10 to open or close the housing 10 like a lid, and including a filter, a drive motor, a grinding blade, and a heater, in which a protrusion 18 is formed at an end of the upper portion of the housing 10, a plate 28a is formed inside the main body 20 and includes a hollow 28 in the corresponding location of the protrusion 18, a push plate 29b is formed at the upper portion of the hollow 28 and is formed inside a vertical guide 29a, and a primary power blocking circuit 31 is formed inside the main body 20, corresponds to the protrusion 18 of the housing 10, and blocks alternating input power.

The primary power blocking circuit 31 comprises a power switch 313 that is electrically switched on/off and has one end connected to an alternating current (AC), a transformer 316 having a primary coil connected to another end of the power switch 313, and relays 314 and 318 that apply or block a power supply to a driver motor 311 and a heater 312, respectively, according to a control signal of a controller 15.

The power switch 313 has a current allowance volume greater than at least 5A such as a micro switch in order to be disposed at a primary end of the transformer 316 by which a current having a relatively large volume flows.

The operation of the household soybean milk and tofu maker having the above-described construction will now be described.

In order to make soybean milk or tofu, when a user puts water and soybeans into the housing 10 and couples the housing 10 and the main body 20, the user places the main body 20 above the housing 10 to insert the protrusion 18 formed at an end of the upper portion of the housing 10 into the hollow 28 formed at the corresponding location to the protrusion 18 of the main body 20.

If the protrusion 18 of the housing 10 is inserted into the hollow 28 of the plate 28a of the main body 20, the protrusion 18 passes through the hollow 28 to push up the push plate 29b formed at the upper portion of the hollow 28. The push plate 29b spreads the force pushed by the protrusion 18 and moves along the vertical guide 29a formed around the hollow 28, thereby contacting the power switch 313 formed at an end of the main body 20 at the corresponding location to the protrusion 18 and turning on the power switch 313.

When the power switch 313 is turned on, a power path from the AC to the transformer 316 is formed via the power switch 313, so that a power supply is applied to the primary end coil of the transformer 316 from the AC, and the power supply is transformed and is sent to a secondary end coil. The power supply induced to the secondary end coil is rectified into a direct current and is applied to an electric device.

Therefore, when the user couples the main body 20 to the upper portion of the housing 10, the protrusion 18 automatically turns on the power switch 313 to apply the power supply, thereby operating the household soybean milk and tofu maker by applying or blocking the power supply according to the coupling between the main body 20 and the housing 10 without a user's additional operation.

As described above, when the power switch 313 remains turned on, the user operates a cooking control button (not shown), and the controller 315 drives the relays 314 and 318, so that the AC is applied to the drive motor 311 and the heater 312 through the relays 314 and 318 to operate the drive motor 311 and the heater 312, thereby automatically proceeding with a process of making soybean milk and tofu according to the cooking selected by the user.

In this regard, since the power switch 313 is the micro switch that is relatively strong in vibration, it is not turned off due to vibration during the operation of the household soybean milk and tofu maker.

Although vibration occurs during the operation of the household soybean milk and tofu maker, the surface contact between the push plate 30 and the power switch 313 leads to maintenance of a surface point, thereby improving vibration-proof performance of a device.

Meanwhile, when the main body 20 is separated from the upper portion of the housing 10, since the protrusion 18 of the housing 10 is released from the hollow 28 of the main body 20, the protrusion 18 does not push up the push plate 29b, so that the power switch 313 is electrically turned off.

When the power switch 313 is turned off, the AC having a relatively high voltage is not applied to the primary coil of the transformer 316, and thus a power supply having a high voltage dangerous to a human body is not applied, thereby preventing a safety accident from occurring.

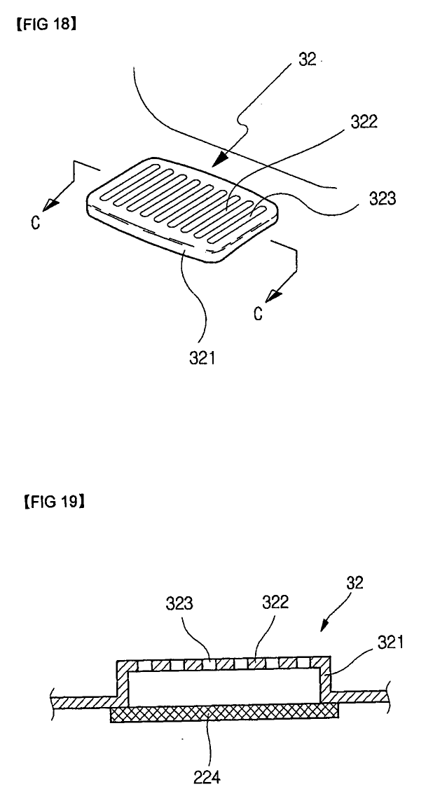

FIG. 17 is a perspective view of a household soybean milk and tofu maker according to another embodiment of the present invention. FIG. 18 is a main perspective view of the household soybean milk and tofu maker of FIG. 17 according to another embodiment of the present invention. FIG. 19 is a cross-sectional view of the household soybean milk and tofu maker of FIG. 18 taken along a line C-C in FIG. 18, according to an embodiment of the present invention.

Referring to FIGS. 17 through 19, the household soybean milk and tofu maker comprises a housing 10 having a cavity, and a main body 20 formed on an upper portion of the housing 10 to open or close the housing 10 like a lid, and including a filter, a drive motor, a grinding blade, and a heater, in which an air vent device 32 has a step 321 at an end of the upper portion of the main body 20, alternatively a plurality of grids 322 for preventing impurities from getting from outside and a plurality of hollows 323 for emitting heat inside thereof, and a filter 324 attached to the lower portion of the hollows 323.

The operation of the household soybean milk and tofu maker having the above-described construction will now be described.

In order to make soybean milk or tofu, when a user puts water and soybeans into the housing 10 and couples the housing 10 and the main body 20, a power supply is automatically applied to proceed with a process of making soybean milk and tofu.

During the process of making soybean milk and tofu, heat at a high temperature is generated from various electric devices including the drive motor formed inside the main body 20. The heat circulates with air through the air vent device 32 formed on the upper portion of the main body 20 and is radiated outside the main body 20, thereby preventing the device from being overheated.

The air vent device 32 radiates hot inside air using the hollows 323 and prevents impurities from getting into the main body 20 using the step 321 and the grids 322 while the household soybean milk and tofu is cleaned.

In addition to the step 321 and the grids 322, the filter 324 formed at the lower portion of the air vent device 32 radiates hot inside air and prevents impurities from getting into the main body 20 while the household soybean milk and tofu is cleaned.

The air vent device 32 has a good visibility owing to the step 321 and the grids 322 so that the user can easily identify the air vent device 32 in order to avoid damage to hot inside heat from the air vent device 32 while making soybean milk and tofu.

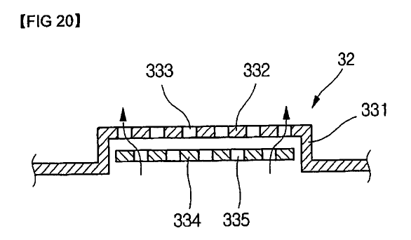

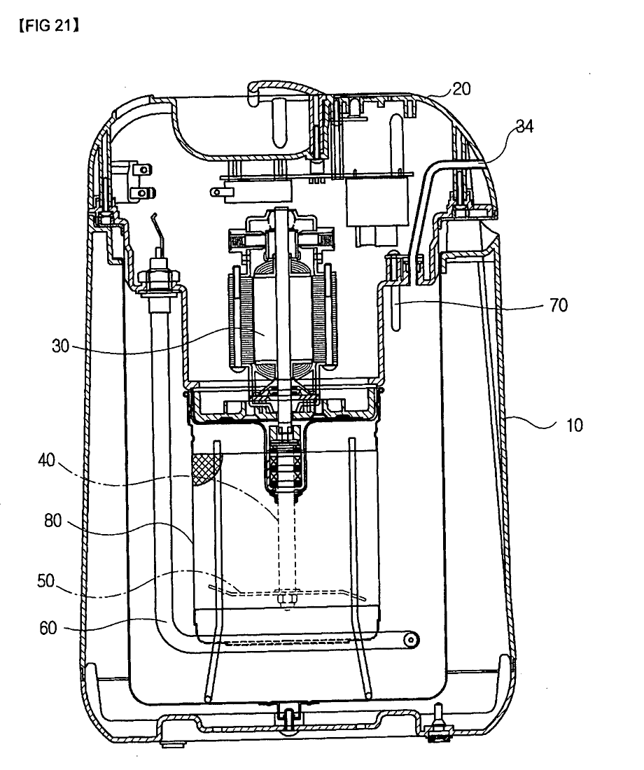

FIG. 20 is a main cross-sectional view of a household soybean milk and tofu maker according to another embodiment of the present invention. Referring to FIG. 20, the household soybean milk and tofu maker comprises a housing having a cavity, and a main body formed on an upper portion of the housing to open or close the housing like a lid, and including a filter, a drive motor, a grinding blade, and a heater, in which an air vent device 33 has a step 321 at an end of the upper portion of the main body 20, alternatively a plurality of grids 332 for preventing impurities from getting from outside and a plurality of hollows 333 for emitting heat inside thereof, and another plurality of grids 334 and hollows 335 are formed under the grids 332 and the hollows 333 in which locations of the grids 332 and the hollows 333 cross those of the grids 334 and hollows 335 each other.

The operation of the household soybean milk and tofu maker having the above-described construction will now be described.

In order to make soybean milk or tofu, when a user puts water and soybeans into the housing and couples the housing and the main body, a power supply is automatically applied to proceed with a process of making soybean milk and tofu.

During the process of making soybean milk and tofu, heat at a high temperature is generated from various electric devices including the drive motor. The heat circulates with air through the air vent device 33 formed on the upper portion of the main body and is radiated outside the main body, thereby preventing the device from being overheated.

The air vent device 33 radiates hot inside air using the hollows 333 and prevents impurities from getting into the main body using the step 331 and the grids 332 while the household soybean milk and tofu is cleaned.

Since the locations of the grids 334 and hollows 335 are formed under to cross the grids 332 and the hollows 333 each other, the air vent device 32 radiates hot inside air using the hollows 335 and prevents impurities from getting into the main body using the grids 334 while the household soybean milk and tofu is cleaned.

The air vent device 33 has a good visibility owing to the step 331 and the grids 332 so that the user can easily identify the air vent device 33 in order to avoid damage to hot inside heat from the air vent device 33 while making soybean milk and tofu.

FIG. 21 is a cross-sectional view of a household soybean milk and tofu maker according to another embodiment of the present invention. Referring to FIG. 21, the household soybean milk and tofu maker comprises a housing 10 having a cavity, and a main body 20 formed on an upper portion of the housing 10 to open or close the housing 10 like a lid, and including a filter, a drive motor, a grinding blade, and a heater, in which a steam exhaust pipe 34 for exhausting steam generated from the housing 10 is formed through the main body 20.

The steam exhaust pipe 34 is curved so that the exhausted steam can collide the curved part and be liquefied.

The operation of the household soybean milk and tofu maker having the above-described construction will now be described.

In order to make soybean milk or tofu, when a user puts water into the housing 10, puts soybeans into a filter net 80, couples the filter net 80 containing soybeans to the lower portion of the main body 20, puts the filter net 80 into the housing 10, and couples the main body 20 to the upper portion of the housing 10. When the main body 20 is coupled to the upper portion of the housing 10, a power supply is automatically applied. Simultaneously if the user operates a manufacturing process selection switch (not shown), a controller (not shown) operates a heating bar 60 and a temperature sensing bar 70, so that soybeans are first heated to a predetermined temperature during a predetermined time of period.

After soybeans are completely heated, the controller (not shown) operates the drive motor 30 to grind soybeans contained in the filter net 80 by using the grinding blade 50 connected to the distal end of the drive shaft 40. While the grinding blade 50 grinds the soybeans, vortex flow is induced in the water received in the housing 10 by the rotating motion of the grinding blade 50. Due to this vortex flow, fine soybean particles which reside in the filter net 80 are moved out of the filter net 80. Therefore, the soybeans grounded by the grinding blade 50 are divided into soybean juice which resides out of the filter net 80 and residue which resides in the filter net 80.

Thereafter, the controller (not shown) actuates again the heating bar 60 and the temperature sensing bar 70 to heat the soybean juice to a second predetermined temperature, by which soybean milk is prepared.

When it is necessary to produce tofu, the user takes out the hot soybean milk from the housing 10. Then, the hot soybean milk is added with a coagulant and then stirred, so that the soybean milk is coagulated. Thereupon, by transferring the resultant silken tofu into a draining container and pressing the silken tofu to drain a part of the water content, tofu, that is, pressed tofu is finally made.

During the making process, a large quantity of steam generated from the housing 10 at the first and second heating is quickly exhausted through the steam exhaust pipe 34 formed through the main body 20, thereby efficiently proceeding with the making process.

In this case, a part of the steam exhausted through the steam exhaust pipe 34 collides the curved part of the steam exhaust pipe 34, is liquefied, and then come back into the housing 10.

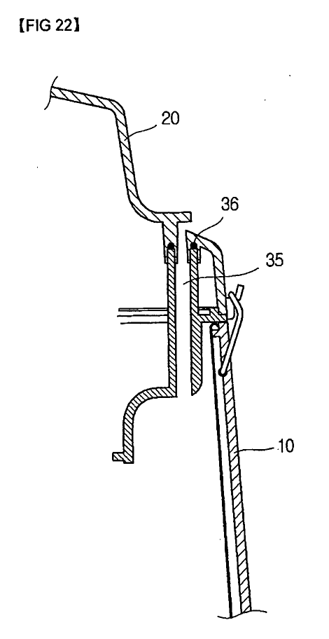

FIG. 22 is a main cross-sectional view of a household soybean milk and tofu maker according to another embodiment of the present invention. Referring to FIG. 22, the household soybean milk and tofu maker comprises a housing 10 having a cavity, and a main body 20 formed on an upper portion of the housing 10 to open or close the housing 10 like a lid, and including a filter, a drive motor, a grinding blade, and a heater, in which a steam exhaust pipe 35 for connecting between the cavity of the housing 10 and outside is formed through the main body 20, in which an O-ring 36 is formed at a connection between the steam exhaust pipe 35 and the main body 20.

The household soybean milk and tofu maker prevents steam through the main body 20 from coming into the main body 20 as much as possible by using the O-ring 36 formed at the connection between the steam exhaust pipe 35 and the main body 20. Except for this matter, the operation of the household soybean milk and tofu maker of the present embodiment is the same as that of the household soybean milk and tofu maker with reference to FIG. 21, and thus its detailed description is not repeated.

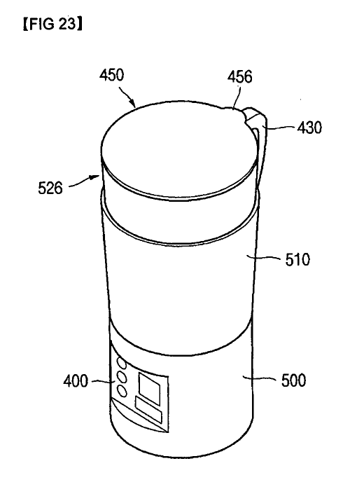

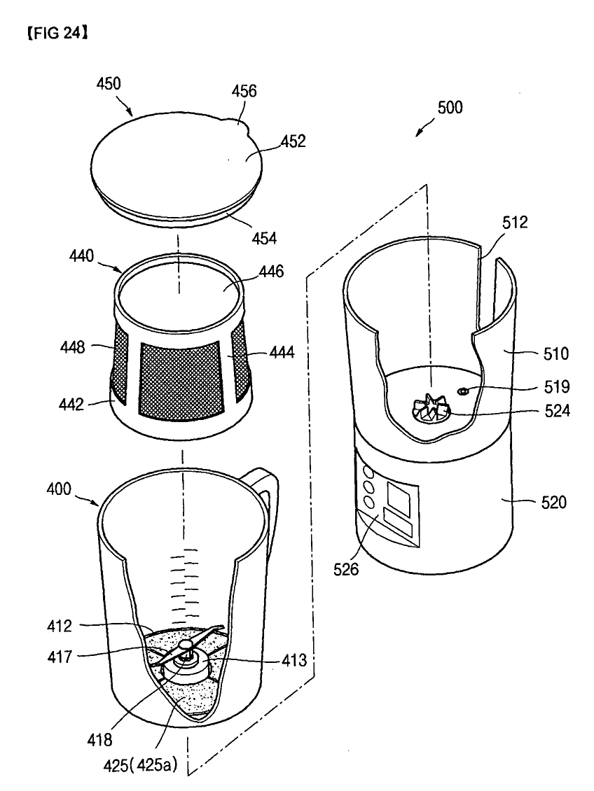

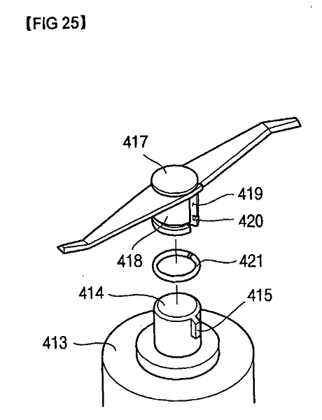

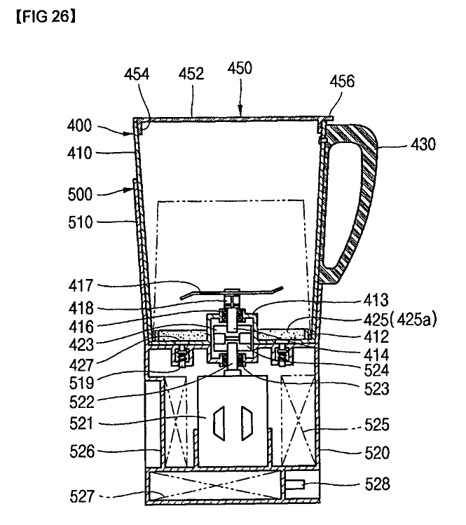

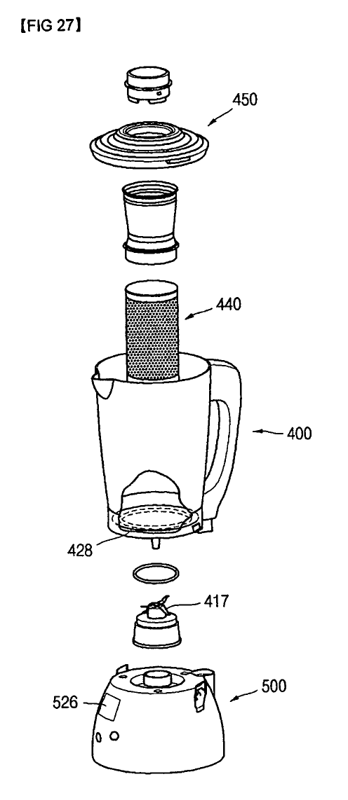

FIG. 23 is a perspective view of a household soybean milk and tofu maker according to another embodiment of the present invention. FIG. 24 is an exploded perspective view of the household soybean milk and tofu maker of FIG. 23 according to another embodiment of the present invention. FIG. 25 is an exploded perspective view of the household soybean milk and tofu maker of FIG. 23 to which a grinding blade is coupled according to another embodiment of the present invention. FIG. 26 is a cross-sectional view of the household soybean milk and tofu maker of FIG. 23 according to another embodiment of the present invention.

Referring to FIGS. 23 through 26, the household soybean milk and tofu maker comprises a filter net 440 containing food materials including grain such as soybeans, a container section 400 including a grinding blade 417 grinding the food materials contained in the filter net 440 and a heater 425 heating the food materials grounded by the grinding blade 417, a cover 450 connected to the upper portion of the container section 400 and sealing the container section 400, and a main body 500 including an insertion section receiving the container section 400 on the upper portion thereof, a drive motor 521 contacting the exterior surface of the container section 400 and applying a rotation force to the grinding blade 417, a controller 525 controlling the heater 428 and the drive motor 521, and a control panel 526 controlling the controller 525.

The container section 400 comprises a cylindrical container 410 that is formed of metal having excellent thermal transmission, is open at an upper portion thereof, and having a diameter whose lower end is slightly shorter than upper end thereof, a handle 430 moving the container 410 at an end of an exterior circumferential surface of the container 410, a measurement scale 411 measuring the amount of the food materials contained in the container 410 in an interior circumferential direction of the container 410, a fixing projection 412 fixing a circumferential surface of an opening section of the filter net 440 in the inner bottom surface of the container 410, the grinding blade 417 grinding the food materials contained in the filter net 440 or the container 410 in the center portion of the bottom surface of the container 410, and the heater 425 heating the food materials contained in the container 410.

The fixing projection 412 is in the shape of a ring spaced by the thickness of the circumferential surface of the opening section of the filter net 440 on the interior circumferential surface of the bottom surface of the container 410. When the opening section of the filter net 440 is disposed between the fixing projection 412 and the interior circumferential surface of the container 410, the fixing projection 412 applies a predetermined pressure to the opening section.

The grinding blade 417 includes a protrusion section 413 having a predetermined section protruded upward in the center bottom portion of the container 410, a grinding blade rotational axis 414 passing through the protrusion section 413 and supported by a pair of bearings 416 in the center portion of the protrusion section 413, the grinding blade 417 detachably fixed to the upper portion of the grinding blade rotational axis 414 to grind the food materials contained in the container 410, and an following gear 523 welded to a followed gear 524 and rotating on the lower portion of the grinding blade rotational axis 414.

A pair of engaging protrusions 415 is projected in an outside direction of the grinding blade rotational axis 414 on the upper portion of the grinding blade rotational axis 414 to which the grinding blade 417 is detachably connected, a detachment section 418 in the shape of a cylinder into which the upper portion of the grinding blade rotational axis 414 is inserted is formed on the bottom portion of the grinding blade 417, an incised engaging groove 419 into which the engaging protrusions 415 are inserted is formed in the detachment section 418 at the corresponding location to that of the engaging protrusions 415, and an insertion groove 420 into which a ring type elastic member 421 is inserted applying a predetermined elastic force to the detachment section 418 on the exterior circumferential surface of the detachment section 418 so as to be coupled to the grinding blade rotational axis 414.

The heater 425 is disposed between the interior circumferential surface of the fixing protrusion 412 and the exterior circumferential surface of the protrusion section 413, and has a cavity through which the protrusion section 413 is projected in the center portion thereof. The heater 425 can be formed as a unit heater 425a in the shape of a plurality of fans arranged in a radial shape toward the exterior of the protrusion section 413. A plurality of heater electrodes 427 applying a power supply from the main body 400 to the heater 425 is formed on the bottom portion of the container 410.

The filter net 440 is in the shape of a cylinder, has an open lower side, and has a diameter of which upper side is a slightly shorter than a lower side, has an engaging end 442 having an interior circumferential surface corresponding to the exterior circumferential surface of the fixing protrusion 412 formed in the inner lower surface of the container on the lower portion thereof, a plurality of support ends 444 extending to the upper side of the engaging end 442, and a top plate 446 sealing the upper side of the filter net 440 on the upper portion of the support ends 444.

A net sieve 448 is formed in a space section formed by the top plate 446, the support ends 444, and the engaging end 442 to externally getting out juice of the food materials grounded in the filter net 440. The top plate 446, the support ends 444, and the engaging end 442 are integrally inject-molded. The net sieve 448 is insert-injected when the top plate 446, the support ends 444, and the engaging end 442 are injected.

The cover 450 seals the upper opening section of the container 410 and includes a cover board 452 in the corresponding shape to the upper shape of the container 410, a sealing projection 454 extending to the lower portion of the cover board 452 and fixedly projected to contact the upper interior circumferential surface of the container 410, and a hanging end 456 formed on an end of the cover board 452 to easily detach the cover 450 from the hanging end 456.

The main body 500 comprises a receiving section 510 for receiving the container 400 on the upper portion thereof and an electrode terminal 519 for applying the power supply to a heater electrode 527 disposed on the bottom surface of the container 410, and a driving section 520 including a drive motor 521 for rotating the grinding blade 417 of the container 410 on the lower portion of the receiving section 510 and the controller 525 for controlling the drive motor 521 and the heater 425.

The receiving section 510 in a cylinder type having an open upper portion is formed corresponding to the exterior shape of the container 410 of the container section 400, and has a handle groove 512 from which the handle 430 disposed in an end of the container 410 is projected when the container 410 is received.

The driving section 520 has a driver motor 521 fixed to the interior upper center portion in which a rotation axis 522 is projected upward in the center of the receiving section 510 and is supported by the pair of bearings 416. The followed gear 524 is formed in an end of the rotation axis 522 to be welded to the following gear 523 disposed in the lower portion of the container 410 and applies the rotation force of the drive motor 521 to the following gear 523.

The controller 525 is disposed to control the heater 425 disposed in the container section 400 and the drive motor 521 in an interior end of the drive section 520, the control panel 526 is disposed to control the controller 525 on the exterior surface of the drive section 520, a power supply section 527 is disposed to apply the power supply to the controller 525, the control panel 526, and the heater 425 in the inner lower portion thereof, and a separate power terminal 528 is disposed to connect an external power supply to the power supply section 527.

The operation of the household soybean milk and tofu maker having the construction described above will now be described.

Processing of soybeans, which are materials of home made tofu, soybean milk, and fine soybean particles, is for example described.

Some soybeans, which are materials of home made tofu, soybean milk, and fine soybean particles, are put into the container 410 of the container section 400. The filter net 440 is coupled to the inner side of the container 410. The engaging end 442 of the filter net 440 is disposed between the fixing projection 412 formed on the inner lower surface of the container 410 and the inner surface of the container 410 and tightly fixed, so that the food materials contained in the container 410 is disposed in the inner side of the filter net 440.

After the cover 450 is placed, if the container section 400 is received in the receiving section 510 of the main body 500, the following gear 523 disposed in the lower portion of the container 410 and the followed gear 524 disposed in the receiving section 510 are welded and received.

Thereafter, if the external power supply is applied to the power supply section 527 through the power terminal 528 of the main body 500, and the control panel 526 is operated, the controller 525 applies the power supply of the power supply section 527 to the drive motor 521 and the heater 425.

The controller 525 heats the soybeans contained in the container 410 using the heater 425, operates the drive motor 521, and grinds the soybeans included in the filter net 440 using the grinding blade 417 disposed in the inner side of the filter net 440. The fine soybean particles that are remaining of the ground soybeans remain in the filter net 440 and are separated from protein juice generated from the ground soybeans.

The heater 425 and the grinding blade 417 is continuously or intermittently at a temperature and time set by the controller 525, the control panel 526 is operated according to kinds of food materials contained in the container 410 to change the settings of the controller 525.

Thereafter, the user puts the protein juice contained in the container 410 in a separate container, adds additives to the protein juice to make soybean milk, adds salt water to the protein juice to make tofu using a frame. The user can use the fine soybean particles (remains) contained in the filter net 440 to make soybean particles soup.

Processing of food materials (e.g., rice, vegetables, beef, etc.) to make a rice soup will now be described.

Some water, previously cleaned food materials (e.g., rice, vegetables, beef, etc.) are put into the container 410 of the container section 400, and the container 410 is sealed using the cover 450.

If the container section 400 is received in the receiving section 510 of the main body 500, the following gear 523 disposed in the lower portion of the container 410 and the followed gear 524 disposed in the receiving section 510 are welded and received.

Thereafter, if the external power supply is applied to the power supply section 527 through the power terminal 528 of the main body 500, and the control panel 526 is operated, the controller 525 applies the power supply of the power supply section 527 to the drive motor 521 and the heater 425.

The controller 525 operates the drive motor 521 to grind the food materials contained in the container 410 using the grinding blade 417 and to heat the food materials using the heater 425, thereby making the rice soup.

The heater 425 and the grinding blade 417 is continuously or intermittently at a temperature and time set by the controller 525, the control panel 526 is operated according to kinds of food materials contained in the container 410 to change the settings of the controller 525.

Thereafter, the user puts the rice soup contained in the container 410 in a separate container.

FIG. 27 is an exploded perspective view of a household soybean milk and tofu maker according to another embodiment of the present invention. Referring to FIG. 27, the household soybean milk and tofu maker comprises a filter net 440 containing food materials including grain such as soybeans, a container section 400 including a grinding blade 417 grinding the food materials contained in the filter net 440 and a heater 425 heating the food materials grounded by the grinding blade 417, a cover 450 connected to the upper portion of the container section 400 and sealing the container section 400, and a main body 500 including an insertion section receiving the container section 400 on the upper portion thereof, a drive motor contacting the exterior surface of the container section 400 and applying a rotation force to the grinding blade 417, a controller controlling the heater 428 and the drive motor 521, and a control panel 526 controlling the controller, in which the heater 428 is embedded in the lower surface of the container section 400.

The operation of the household soybean milk and tofu maker of the present embodiment is the same as that of the household soybean milk and tofu maker with reference to FIGS. 23 through 26 except that the heater 428 is embedded in the lower surface of the container section 400. Thus, the detailed description thereof is not repeated.

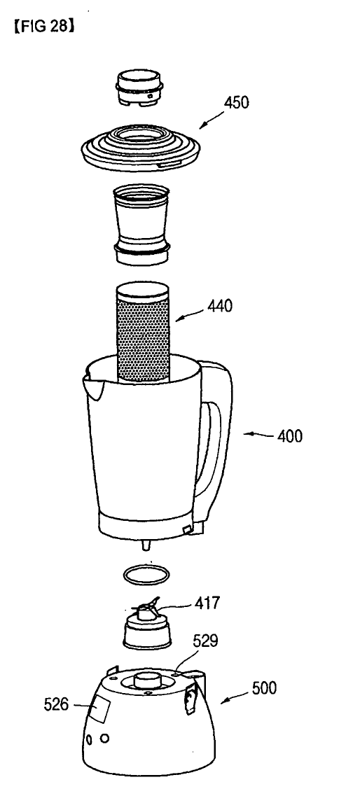

FIG. 28 is an exploded perspective view of a household soybean milk and tofu maker according to another embodiment of the present invention. Referring to FIG. 28, the household soybean milk and tofu maker comprises a filter net 440 containing food materials including grain such as soybeans, a container section 400 including a grinding blade 417 grinding the food materials contained in the filter net 440 and a heater 425 heating the food materials grounded by the grinding blade 417, a cover 450 connected to the upper portion of the container section 400 and sealing the container section 400, and a main body 500 including an insertion section receiving the container section 400 on the upper portion thereof, a drive motor contacting the exterior surface of the container section 400 and applying a rotation force to the grinding blade 417, a controller controlling the heater 428 and the drive motor 521, and a control panel 526 controlling the controller, in which a projection 520 is formed on the upper surface of the main body 500 and a coupling groove is formed on the lower surface of the container section 400 to be coupled to the projection 529.

The operation of the household soybean milk and tofu maker having the above-described construction will now be described.

When a user couples the main body 500 to the container section 400 in order to make soybean milk or tofu, if the container section 400 is placed on the upper portion of the main body 500 while the projection 529 of the main body 500 matches well the coupling groove of the container section 400, the projection 529 formed on the upper surface of the main body 500 is coupled to the coupling groove formed in the lower surface of the container section 400, so that the main body 500 is firmly coupled to the container section 400.

If the projection 529 of the main body 500 does not match the coupling groove of the container section 400, the projection 529 is coupled to the coupling groove owing to the weight of the container section 400, so that the projection 529 and the coupling groove can be coupled easily and continuously.

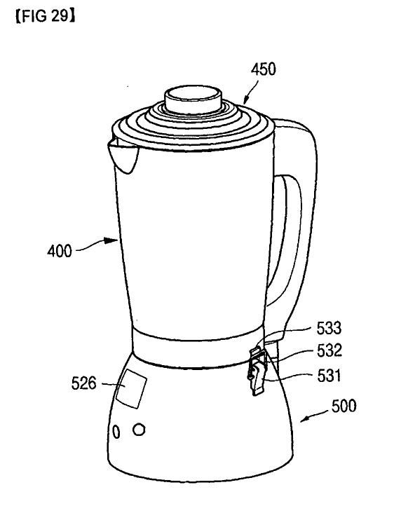

FIG. 29 is a perspective view of a household soybean milk and tofu maker according to another embodiment of the present invention. Referring to FIG. 29, the household soybean milk and tofu maker comprises a filter net 440 containing food materials including grain such as soybeans, a container section 400 including a grinding blade 417 grinding the food materials contained in the filter net 440 and a heater 425 heating the food materials grounded by the grinding blade 417, a cover 450 connected to the upper portion of the container section 400 and sealing the container section 400, and a main body 500 including an insertion section receiving the container section 400 on the upper portion thereof, a drive motor contacting the exterior surface of the container section 400 and applying a rotation force to the grinding blade 417, a controller controlling the heater 428 and the drive motor 521, and a control panel 526 controlling the controller, in which a hook plate 531 is formed at an end of the exterior surface of the main body 500 to be freely rotated, a hook 532 connected to the hook plate 531 to be freely rotated, and a locking piece 533 is projected at an end of the container section 400 to hang the hook 532.

The hook 532 is in the shape of a wire surrounding the exterior of the hook plate 531, and has a rotation center axis at a different location from that of the hook plate 531.

The operation of the household soybean milk and tofu maker having the above-described construction will now be described.

When a user couples the main body 500 to the container section 400 in order to make soybean milk or tofu, the hook 532 is rotated to hang the upper portion of the hook 532 to the locking piece 533.

If the lower end portion of the hook plate 531 is pushed, the upper portion of the hook 532 is pulled by the locking piece 533, and the lower portion thereof is pulled by the hook plate 531, so that the locking piece 533 and the hook plate 531 pull the hook 532 up and down, thereby firmly coupling the hook 532 to the locking piece 533.

When the hook 532 is coupled and locked to the locking piece 533, the container section 400 is pulled down via the elastic force of the hook 532, so that the main body 500 and the container section 400 are tightly coupled.

Therefore, vibration does not occur due to mismatch between the main body 250 and the container section 400. Even though the household soybean milk and tofu maker falls down due to a user's mistake or external shock when being used, the contents having a high temperature are not spilt, thereby preventing a safety accident from occurring in advance.

After soybean milk and tofu are completely made, in order to separate the container section 400 and the main body 20 from each other, if the lower portion of the hook plate 531 is pulled toward outside, the hook plate 531 does not pull the hook 532 and thus the upper portion of the hook 532 that is hung to the hook piece 533 is released from the hook 532, so that the user can separate the container section 400 from the main body 20.

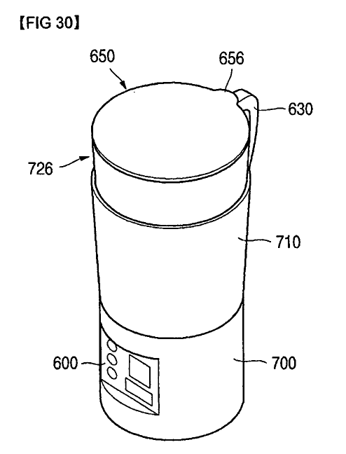

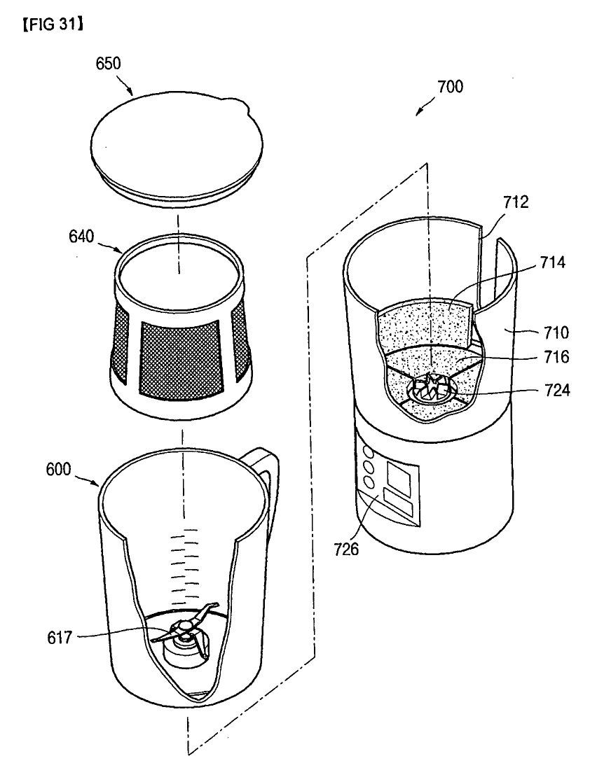

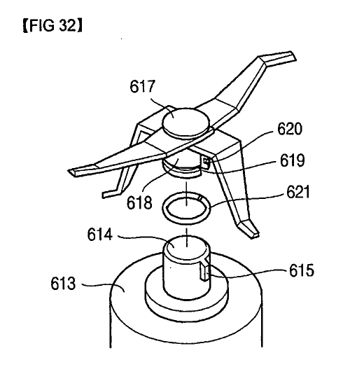

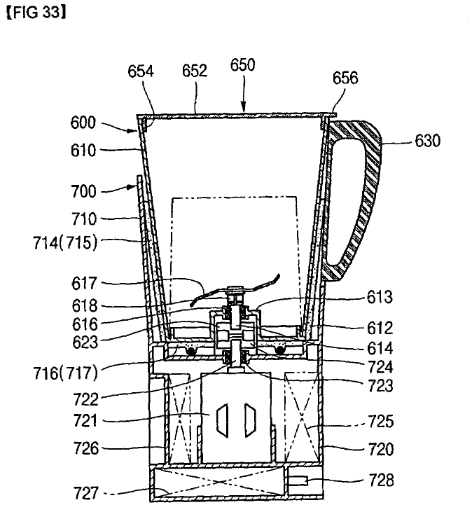

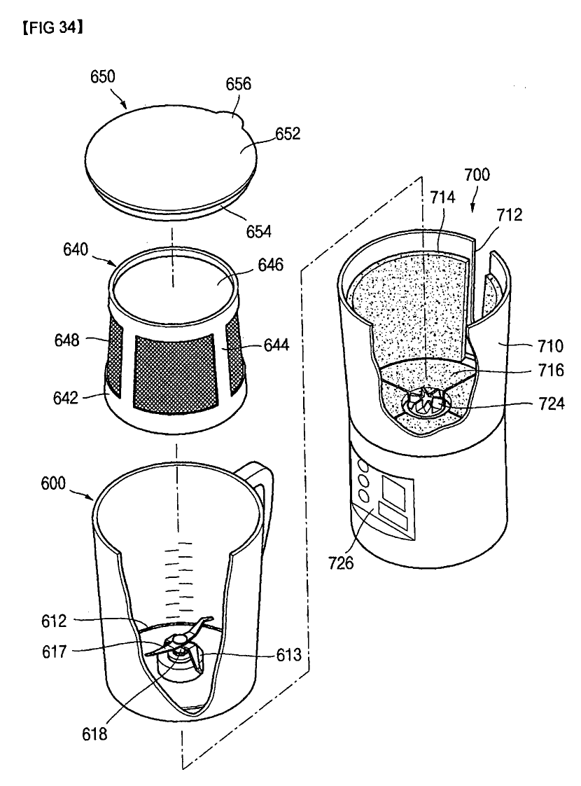

FIG. 30 is a perspective view of a household soybean milk and tofu maker according to another embodiment of the present invention. FIG. 31 is an exploded perspective view of the household soybean milk and tofu maker of FIG. 30 according to another embodiment of the present invention. FIG. 32 is an exploded perspective view of the household soybean milk and tofu maker of FIG. 30 to which a grinding blade is coupled according to another embodiment of the present invention. FIG. 33 is a cross-sectional view of the household soybean milk and tofu maker of FIG. 30 according to another embodiment of the present invention.

Referring to FIGS. 30 through 33, the household soybean milk and tofu maker comprises a filter net 640 containing food materials including grain such as soybeans, a container section 600 including a grinding blade 617 grinding the food materials contained in the filter net 640, a cover 650 connected to the upper portion of the container section 600 and sealing the container section 600, and a main body 700 including an insertion section receiving the container section 600 on the upper portion thereof, a drive motor 721 and heaters 714 and 716 contacting the exterior surface of the container section 600 and applying a rotation force to the grinding blade 617, and heating the container section 600, respectively, a controller 725 controlling the drive motor 721 and heaters 714 and 716, and a control panel 726 controlling the controller 725.

The container section 600 comprises a cylindrical container 610 that is formed of metal having excellent thermal transmission, has an open upper portion, and having a diameter whose lower end is slightly shorter than upper end thereof, a handle 630 moving the container 610 at an end of an exterior circumferential surface of the container 610, a measurement scale 611 measuring the amount of the food materials contained in the container 610 in an interior circumferential direction of the container 610, a fixing projection 612 fixing a circumferential surface of an opening section of the filter net 640 in the inner bottom surface of the container 610, and the grinding blade 617 grinding the food materials contained in the filter net 640 or the container 610 in the center portion of the bottom surface of the container 610.

The fixing projection 612 is in the shape of a ring spaced by the thickness of the circumferential surface of the opening section of the filter net 640 on the interior circumferential surface of the bottom surface of the container 610. When the opening section of the filter net 640 is disposed between the fixing projection 612 and the interior circumferential surface of the container 610, the fixing projection 612 applies a predetermined pressure to the opening section.

The grinding blade 617 includes a protrusion section 613 having a predetermined section protruded upward in the center bottom portion of the container 610, a grinding blade rotational axis 614 passing through the protrusion section 613 and supported by a pair of bearings 616 in the center portion of the protrusion section 613, the grinding blade 617 detachably fixed to the upper portion of the grinding blade rotational axis 614 to grind the food materials contained in the container 610, and an following gear 723 welded to a followed gear 724 and rotating on the lower portion of the grinding blade rotational axis 614.

A pair of engaging protrusions 615 is projected in an outside direction of the grinding blade rotational axis 614 on the upper portion of the grinding blade rotational axis 614 to which the grinding blade 617 is detachably connected, a detachment section 618 in the shape of a cylinder into which the upper portion of the grinding blade rotational axis 614 is inserted is formed on the bottom portion of the grinding blade 617, an incised engaging groove 619 into which the engaging protrusions 615 are inserted is formed in the detachment section 618 at the corresponding location to that of the engaging protrusions 615, and an insertion groove 620 into which a ring type elastic member 621 is inserted applying a predetermined elastic force to the detachment section 618 on the exterior circumferential surface of the detachment section 618 so as to be coupled to the grinding blade rotational axis 614.

The filter net 640 is in the shape of a cylinder, has an open lower side, and has a diameter of which upper side is a slightly shorter than a lower side, has an engaging end 642 having an interior circumferential surface corresponding to the exterior circumferential surface of the fixing protrusion 612 formed in the inner lower surface of the container 610 on the lower portion thereof, a plurality of support ends 644 extending to the upper side of the engaging end 642, and a top plate 646 sealing the upper side of the filter net 640 on the upper portion of the support ends 644.

A net sieve 648 is formed in a space section formed by the top plate 646, the support ends 644, and the engaging end 642 to externally getting out juice of the food materials grounded in the filter net 640. The top plate 646, the support ends 644, and the engaging end 642 are integrally inject-molded. The net sieve 648 is insert-injected when the top plate 646, the support ends 644, and the engaging end 642 are injected.

The cover 650 seals the upper opening section of the container 610 and includes a cover board 652 in the corresponding shape to the upper shape of the container 610, a sealing projection 654 extending to the lower portion of the cover board 652 and fixedly projected to contact the upper interior circumferential surface of the container 610, and a hanging end 656 formed on an end of the cover board 652 to easily detach the cover 650 from the hanging end 656.

The main body 700 comprises a receiving section 710 for receiving the container 600 on the upper portion thereof and the heaters 714 and 716 contacting the bottom surface and the exterior circumferential surface of the container 610 and heating the container 610, and a driving section 720 including a drive motor 721 for rotating the grinding blade 617 of the container 610 on the lower portion of the receiving section 710 and the controller 725 for controlling the heaters 714 and 716 and the drive motor 721.

The receiving section 710 in a cylinder type having an open upper portion is formed corresponding to the exterior shape of the container 610 of the container section 600, and has a handle groove 712 from which the handle 630 disposed in an end of the container 610 is projected when the container 610 is received.

The side heater 714 can be formed as a plurality of side unit heaters 715 having circular cross-sections in the portion excluding the handle groove 712. The bottom heater 716 has a space section in which the followed gear 724 welded to the following gear 723 disposed in the lower surface of the container 610 in the center portion thereof, and can be formed as a plurality of bottom unit heaters 717 in the shape of fans.

The driving section 720 has the driver motor 721 fixed to the interior upper center portion in which a rotation axis 722 is projected upward in the space section disposed in the center of the bottom heater 716 and is supported by a pair of bearings 723. The followed gear 724 is formed in an end of the rotation axis 722 to be welded to the following gear 723 disposed in the lower portion of the container 610 and applies the rotation force of the drive motor 721 to the following gear 723.

The controller 725 is disposed to control the heaters 714 and 716 disposed in the container section 600 and the drive motor 721 in an interior end of the drive section 720, the control panel 726 is disposed to control the controller 725 on the exterior surface of the drive section 720, a power supply section 727 is disposed to apply the power supply to the controller 725, the control panel 726, and the heaters 714 and 716 in the inner lower portion thereof, and a separate power terminal 728 is disposed to connect an external power supply to the power supply section 727.

The operation of the household soybean milk and tofu maker having the construction described above will now be described.

Processing of soybeans, which are materials of home made tofu, soybean milk, and fine soybean particles, is for example described.

Some soybeans, which are materials of home made tofu, soybean milk, and fine soybean particles, are put into the container 610 of the container section 600. The filter net 640 is coupled to the inner side of the container 610. The engaging end 642 of the filter net 640 is disposed between the fixing projection 612 formed on the inner lower surface of the container 610 and the inner surface of the container 610 and tightly fixed, so that the food materials contained in the container 610 is disposed in the inner side of the filter net 640.

After the cover 650 is placed, if the container section 600 is received in the receiving section 710 of the main body 700, the following gear 723 disposed in the lower portion of the container 610 and the followed gear 724 disposed in the receiving section 710 are welded and received, and the exterior circumferential surface and the bottom surface of the container 610 contact the side heater 714 and the bottom heater 716 disposed in the receiving section 710 and received.

Thereafter, if the external power supply is applied to the power supply section 727 through the power terminal 728 of the main body 700, and the control panel 726 is operated, the controller 725 applies the power supply of the power supply section 727 to the drive motor 721 and the heater 714 and 716.

The controller 725 heats the soybeans contained in the container 610 using the heater 625, operates the drive motor 721, and grinds the soybeans included in the filter net 640 using the grinding blade 617 disposed in the inner side of the filter net 640. The fine soybean particles that are remaining of the ground soybeans remain in the filter net 640 and are separated from protein juice generated from the ground soybeans.

The heater 714 and 716 and the grinding blade 417 are continuously or intermittently at a temperature and time set by the controller 725, the control panel 726 is operated according to kinds of food materials contained in the container 610 to change the settings of the controller 725.

Thereafter, the user puts the protein juice contained in the container 610 in a separate container, adds additives to the protein juice to make soybean milk, adds salt water to the protein juice to make tofu using a frame. The user can use the fine soybean particles (remains) contained in the filter net 640 to make soybean particles soup.

Processing of food materials (e.g., rice, vegetables, beef, etc.) to make a rice soup will now be described.

Some water, previously cleaned food materials (e.g., rice, vegetables, beef, etc.) are put into the container 610 of the container section 600, and the container 610 is sealed using the cover 650.

If the container section 600 is received in the receiving section 710 of the main body 700, the following gear 723 disposed in the lower portion of the container 610 and the followed gear 724 disposed in the receiving section 710 are welded and received, and the exterior circumferential surface and the bottom surface of the container 610 contact the side heater 714 and the bottom heater 716 disposed in the receiving section 710 and received.

Thereafter, if the external power supply is applied to the power supply section 727 through the power terminal 728 of the main body 700, and the control panel 726 is operated, the controller 725 applies the power supply of the power supply section 727 to the drive motor 721 and the heaters 714 and 716.

The controller 725 operates the drive motor 721 to grind the food materials contained in the container 610 using the grinding blade 417 and to heat the food materials using the heaters 714 and 716, thereby making the rice soup.

The heater 625 and the grinding blade 617 is continuously or intermittently at a temperature and time set by the controller 725, the control panel 726 is operated according to kinds of food materials contained in the container 610 to change the settings of the controller 725.

Thereafter, the user puts the rice soup contained in the container 610 in a separate container.

FIG. 34 is an exploded perspective view of a household soybean milk and tofu maker according to another embodiment of the present invention. Referring to FIG. 23, the household soybean milk and tofu maker comprises a filter net 640 containing food materials including grain such as soybeans, a container section 600 including a grinding blade 617 grinding the food materials contained in the filter net 640, a cover 650 connected to the upper portion of the container section 600 and sealing the container section 600, and a main body 700 including an insertion section receiving the container section 600 on the upper portion thereof, a drive motor and heaters 714 and 716 contacting the exterior surface of the container section 600 and applying a rotation force to the grinding blade 617, and heating the container section 600, respectively, a controller controlling the drive motor and heaters 714 and 716, and a control panel 726 controlling the controller, in which the heaters 714 and 716 are the side heater 714 and the bottom heater 716, respectively, and the height of the side heater 714 is a half of that of the receiving section 710.

The operation of the household soybean milk and tofu maker of the present embodiment is the same as that of the household soybean milk and tofu maker with reference to FIGS. 30 through 33 except that the height of the side heater 714 is a half of that of the receiving section 710. Thus, the detailed description thereof is not repeated.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A household soybean milk and tofu maker comprising a housing having a cavity therein and a main body formed in the form of a lid on an upper portion of the housing to open or close the housing, comprising:
a handle rotatably formed on the upper portions of both sides of the housing in order to move the housing;
a locking section having an engaging hole and an engaging piece at an end of the inner portion of the handle;
a protrusion piece protruded from an end of an exterior surface of the main body in order to be coupled with the engaging piece of the locking section;
a compression piece elastically supported by a spring at an end of the main body in order to push the engaging piece,
wherein a projection is formed at an end of the upper portion of the housing, and a coupling groove is formed at an end of the lower portion of the main body to be coupled to the projection.

2. A household soybean milk and tofu maker comprising a housing having a cavity therein and a main body formed in the form of a lid on an upper portion of the housing to open or close the housing, comprising:
a hook plate formed at an end of the exterior surface of the housing to be freely rotated;
a hook connected to the hook plate to be freely rotated; and
a locking piece projected at an end of the main body in order to hang the hook,
wherein a projection is formed at an end of the upper portion of the housing, and a coupling groove is formed at an end of the lower portion of the main body to be coupled to the projection.

3. A household soybean milk and tofu maker comprising a housing having a cavity therein and a main body formed in the form of a lid on an upper portion of the housing to open or close the housing, comprising:
a handle rotatably formed on the upper portions of both sides of the housing in order to move the housing;
a locking section having an engaging hole and an engaging piece at an end of the inner portion of the handle, a protrusion piece protruded from an end of an exterior surface of the main body in order to be coupled with the engaging piece of the locking section, and a compression piece elastically supported by a spring at an end of the main body in order to push the engaging piece,
wherein an air vent device is formed in the upper portion of the main body in which a step is formed at an end of the upper portion of the main body, a plurality of grids for preventing impurities from getting from outside and a plurality of hollows for emitting heat inside thereof are alternately formed, and a filter is attached to the lower portion of the hollows.

4. A household soybean milk and tofu maker comprising a housing having a cavity therein and a main body formed in the form of a lid on an upper portion of the housing to open or close the housing, comprising:
a handle rotatably formed on the upper portions of both sides of the housing in order to move the housing;
a locking section having an engaging hole and an engaging piece at an end of the inner portion of the handle;
a protrusion piece protruded from an end of an exterior surface of the main body in order to be coupled with the engaging piece of the locking section; and
a compression piece elastically supported by a spring at an end of the main body in order to push the engaging piece,
wherein an air vent device is formed in the upper portion of the main body in which a step is formed at an end of the upper portion of the main body, a plurality of first hollows for emitting heat inside of the main body and a plurality of first grids for preventing impurities from getting from outside are alternately formed, a plurality of second hollows and a plurality of second grids are formed under the first hollows and the first grids, and the locations of the first hollows and the first grids cross those of the second hollows and the second grids each other.

5. A household soybean milk and tofu maker comprising a housing having a cavity therein and a main body formed in the form of a lid on an upper portion of the housing to open or close the housing, comprising:
a handle rotatably formed on the upper portions of both sides of the housing in order to move the housing;
a locking section having an engaging hole and an engaging piece at an end of the inner portion of the handle;
a protrusion piece protruded from an end of an exterior surface of the main body in order to be coupled with the engaging piece of the locking section; and
a compression piece elastically supported by a spring at an end of the main body in order to push the engaging piece,
wherein a steam exhaust pipe is formed through the main body to externally exhaust steam generated from the main body during a cooking process.

6. A household soybean milk and tofu maker comprising:
a filter net containing food materials including grain such as soybeans;
a container section including a grinding blade grinding the food materials contained in the filter net and a heater heating the food materials grounded by the grinding blade;
a cover connected to the upper surface of the container section and sealing the container section; and
a main body including an insertion section receiving the container section on the upper portion thereof, a drive motor contacting the exterior circumferential surface of the container section and applying a rotation force to the grinding blade, a controller controlling the heater and the drive motor, and a control panel controlling the controller.

7. The household soybean milk and tofu maker of claim 6, wherein the heater is embedded in the lower surface of the container section.

8. The household soybean milk and tofu maker of claim 6, wherein a projection is formed on the upper surface of the main body, and a coupling groove is formed on the lower surface of the container section to be coupled to the projection.

9. The household soybean milk and tofu maker of claim 6, further comprising:
a hook plate formed at an end of the exterior surface of the main body to be freely rotated;
a hook connected to the hook plate to be freely rotated; and
a locking piece projected at an end of the container section in order to hang the hook.

10. A household soybean milk and tofu maker comprising:
a filter net containing food materials including grain such as soybeans;
a container section including a grinding blade grinding the food materials contained in the filter net;
a cover connected to the upper surface of the container section and sealing the container section; and
a main body including an insertion section receiving the container section on the upper portion thereof, a drive motor and heaters contacting the exterior circumferential surface of the container section and the drive motor applying a rotation force to the grinding blade, and the heaters heating the container section, a controller controlling the heaters and the drive motor, and a control panel controlling the controller.

11. The household soybean milk and tofu maker of claim 10, wherein the heaters are a side heater and a bottom heater.
